(19) United States
(12) Patent Application Publication
(10) Pub. No.: US 2017/0248249 A1
(43) Pub. Date: Aug. 31, 2017

(54) ELECTROMAGNETIC VALVE WITH SPRING TONGUES

(71) Applicant: ZF Friedrichshafen AG, Friedrichshafen (DE)

(72) Inventors: Lothar Kiltz, Ravensburg (DE); Michael Pantke, Friedrichshafen (DE)

(73) Assignee: ZF Friedrichshafen AG, Friedrichshafen (DE)

(21) Appl. No.: 15/441,964

(22) Filed: Feb. 24, 2017

(30) Foreign Application Priority Data
Feb. 26, 2016 (DE) 10 2016 203 024.8

(51) Int. Cl. F16K 31/06; F16K 31/08; F16K 11/10

(52) U.S. Cl. CPC F16K 31/0682; F16K 11/10; F16K 31/0624; F16K 31/082

(57) ABSTRACT

The invention relates to an electrically operable valve with an electrical coil and with several spring tongues, which are movable by means of a magnetic field generated by the coil between a first switch position and a second switch position each and with several first valve openings, which are opened when the spring tongues are in the first switch position and which are closed by means of the spring tongues when the spring tongues are in the second switch position.

### BACKGROUND

1. Technical Field

The invention relates to an electrically operable valve with at least one electric coil by means of which a locking element can be operated so that several valve openings of the valve can be closed and opened.

2. Background Information

Such a valve is known from DE 601 22 162 T2. Provision is hereby made for a spring tongue (linear anchor made from flat spring steel). The spring tongue is movable back and forth between two switch positions by means of an electric coil. In each of the two switch positions, the spring tongue closes a first valve opening and opens a second valve opening at the same time.

The drawback of this solution is that only a very small cross-section can be opened or closed with the spring tongue by means of which a fluid can flow through the valve. It is therefore the task of the invention to provide for a valve that can release and close a larger flow cross-section.

### BRIEF SUMMARY

This task is achieved through an electrically operable valve in accordance with the main claim. Preferred embodiments may be taken from the dependent claims.

An electrically operable valve is therefore suggested. It has an electric coil and several spring tongues that are movable each by means of a magnetic field generated by an electric coil between a first switch position (particularly open position) and a second switch position (particularly closed position). Furthermore, several first valve openings are provided which are open when the spring tongues are in the first switch position and which are closed by means of the spring tongues when the spring tongues are in the second switch position.

Through the several spring tongues and the several first valve openings, an enlarged flow cross-section for a fluid (such as a liquid or a gas) can therefore be provided, which flows through the valve or where its flow shall be blocked by the valve. Part of the spring tongue itself can hereby serve as the closure, for example by the part placing itself against the valve opening in a sealing manner, or a separate closure may be intended that is connected with one spring tongue each or which is formed on the spring tongue and that places itself against the respective valve opening in a sealing manner to close the valve.

Since several valve openings are intended, the fluid part of the valve is inherently redundant in the sense that the clogging of a valve opening through washed in dirt doesn't result in the breakdown of the valve. Creating a redundancy also of the electric circuit of the valve can be achieved by that the coil is designed with two independent windings with separate electrical connections.

Each of the first valve openings is preferably assigned to one of the spring tongues.

Exactly one spring tongue can thus be provided for each valve opening or several valve openings share a joint spring tongue. A closure arranged on the spring tongue thereby closes the respective assigned valve opening when the spring tongue is in the second switch position.

The closure may either be formed by the spring tongue itself here as well, for example through part of the spring tongue, or the closure is formed as a separate component that is firmly connected with the spring tongue.

At least two of the spring tongues are preferably executed so that they open or close the respective valve opening with different magnetic field strengths. This means, for example that one of the first magnetic field strength of the magnetic field generated by the coil of merely one of the first valve openings is opened or closed by the respective spring tongue and that with a hereby different second magnetic field strength, at least one more of the first valve openings is also opened or closed. In particular, the spring tongues may be executed such that they all open or close the respective assigned first valve opening with different magnetic field strengths. It can thus be adjusted in dependence of the electric current supplied to the coil and thus in dependence of the magnetic field strength generated by the coil, how many of the first valve openings are opened or closed. The flow cross section opened by the valve can therefore be adjusted virtually proportional to the electrical current (=current proportional) supplied to the coil.

The opening or closing of at least two of the spring tongues with different magnetic field strengths is preferably achieved by that
the at least two of the spring tongues have different spring constants
the at least two of the spring tongues in their starting position, when the coil doesn't generate a magnetic field (especially in the first or second switch position), are pre-stressed differently strong against the respective first valve opening,
the at least two of the spring tongues in their starting position, when the coil doesn't generate a magnetic field (especially in the first or second switch position), are spaced differently wide from the respective first valve opening,
the at least two of the spring tongues are formed different geometrically,
the at least two of the spring tongues consist of different magnetically effective materials,
pole shoes, which at least two of the spring tongues each place themselves against when in actuated state when the coil creates a sufficiently strong magnetic field to activate the valve are formed different geometrically.

The spring tongues can therefore consist of different materials or have different dimensions to react differently strong to the magnetic field generated by the coil. For example, the spring tongues can consist of a plastic matrix, in which a different number of iron particles or other magnetically effective materials is embedded. The above measures can be used individually or (all or individuals) in combination with each other.

At least a second valve opening is preferably also provided, which is arranged to one of the spring tongues and one of the first valve openings such that the first valve opening is opened in the first switch position and the second valve opening is closed by means of the spring tongue and that the second valve opening is opened in the second switch position and the first valve opening is closed by means of the spring tongue. A 3/2 valve can hereby be created.

In particular, a corresponding second valve opening is provided for each of the first valve openings. The spring tongue of a spring tongue arranged to one of the first and second valve opening is especially arranged spatially between this first and second valve opening. Depending on whether the coil is electrically powered or unpowered, i.e. so that a magnetic field is formed or not formed, one of the two opposing valve openings is then closed by means of the spring tongue and the respective other one is opened. A 3/2 pressure control valve may thereby be created in a simple way, for example.

The spring tongues are preferably attached or arranged on a joint carrier element. This implies that the spring tongues are formed with the joint carrier element in one piece by means of slots. For example, the spring tongues can be formed in the carrier elements with slots.

Provision is preferably also made for that the spring tongues are arranged in longitudinal direction of the coil. This means that the spring tongues essentially extend along the longitudinal direction of the coil. In particular, the spring tongues are hereby arranged in a ring, whereby one longitudinal axis of this spring tongue ring runs coaxially or in parallel to the longitudinal axis of the coil.

The valve openings preferably form openings, such as bores that run radially to the longitudinal axis of the coil. In other words, the valve openings run accordingly right-angled to the longitudinal axis of the coil and to the longitudinal axis of the spring tongues. The spring tongues can thereby close the valve openings in a particularly simple manner.

In addition, provision is preferably made for that the spring tongues are arranged radially outside or inside the coil. For example, the spring tongues form a spring tongue ring, which is arranged radially outside or inside the coil and which runs coaxially or parallel to the longitudinal axis of the coil. The valve openings are hereby especially arranged inside the area of an axial end of the coil (front side).

The spring tongues can consist or be produced from ferromagnetic metal for example, or from plastic with ferromagnetic inclusions or also from another magnetically effective material that a force may be exerted on by means of a magnetic field. In particular, if the spring tongues are formed as a spring tongue ring, these are easy to manufacture by means of press-bending technology.

The valve seats of the valve openings can take on any desired suitable form, for example, circular or slit, with or without a spherical or conical depression. The closure assigned to one spring tongue can additionally be provided with a geometry corresponding to the valve seat to improve the sealing performance. In particular, the closure may be executed hemispherical or conical.

The suggested valve is characterized by a high dynamic, which is attributable to that it merely has low moving masses and no friction and a small formation of eddy currents due to the thin-walled elastic spring tongues. It is furthermore cost-efficient and realizable with few parts. Because of its high dynamic, it is resilient against active vibrations. Moreover, it does not tend to a seat bounce. It is low-wear as the spring tongues don't require any mechanical bearing. Due to the low mass of the spring tongues, the wear of the valve seats on the valve openings is also quite minor. Since the valve openings act as a seat valve with the respective spring tongue, it also results in insensitivity to contamination. The spring tongue mainly combines the elements magnet armature, return spring, and valve piston that exist in common valves. A permanent magnet can furthermore be provided in the valve to keep the end positions of the spring tongues on the coil without the supply of electrical energy. For example, provision can be made to permanently magnetize the spring tongues to either open or close the valve depending on the current flow direction through the coil (and a respective alignment of the magnetic field).

### BRIEF DESCRIPTION OF THE DRAWINGS

In the following, the invention is clarified by means of figures that further preferred embodiments of the invention may be taken from. The figures show in schematic representation:

FIG. 1 is a first embodiment of a valve in a closed position,

FIG. 2 is the first realization of the valve in an open position,

FIG. 3 is a second embodiment of a valve in an open position,

FIG. 4 is the second embodiment of the valve in a closed position,

FIGS. 5a to 5c is a third embodiment of a valve in different open and closed positions,

FIGS. 6a to 6c is a fourth embodiment of a valve in different open and closed positions,

FIG. 7 is a spring tongue ring,

FIGS. 8a and 8b are closures and valve openings of a valve,

FIGS. 9a and 9b is a fifth embodiment of a valve in different open and closed positions

FIGS. 10a and 10b is a sixth embodiment of a valve in different open and closed positions.

DETAILED DESCRIPTION OF THE DRAWINGS AND THE PRESENTLY PREFERRED EMBODIMENTS

In the figures, the same or at least similarly functional components/ elements are provided with the same reference signs.

FIG. 1 shows an electrically operable valve by means of which a fluid flow can be enabled (valve opened) and prevented (valve closed). For this purpose, the valve has several first valve openings 1 by means of which the fluid can flow through the valve in the opened state. The valve furthermore comprises an electrical coil 2 that can be powered with an electrical current (voltage U, current I). Depending on the supplied current strength, a magnetic field forms in the area of the coil 2 in a familiar way.

The coil 2 is embedded in a magnet yoke 3. In the area of an axial front of the coil 2, the magnet yoke 3 has one or several pole shoes 4. The magnet yoke is intended to conduct the magnetic field as well as for the magnetic shielding of the surroundings of the coil 2. Furthermore, the valve has elastic valve piston segments 5, hereinafter referred to as “spring tongues”. The spring tongues 5 are movable by means of the magnetic field generated by the coil between a first switch position (here, by way of example: open position), and a second switch position (here, by way of example: closed position). The spring tongues 5 bend in the process. One of these two switch positions preferably corresponds to a starting position of the spring tongues 5, if the coil 2 is not powered. In this starting position, the spring tongue 5 preferably moves back autonomously as soon as there is no longer a magnetic field.

Each of the first valve openings 1 has a spring tongue 5 assigned to it. The first valve opening 1 is mainly open (fluid-conducting) when the respective spring tongue 5 is in the first switch position. Then again, the first valve opening 1 is closed by means of the respective spring tongue 5 (impermeable to fluids) when this spring tongue 5 is in the second switch position. This closed position is represented in FIG. 1. In the embodiment represented in FIG. 1, the spring tongues 5 lie against the respectively assigned first valve openings 1 in their initial position (i.e. coil 2 unpowered) so that these are closed. Here, they can particularly be pre-stressed against the valve opening 1. There is therefore a first pressure pB in an inside area of the valve, while a second pressure pA that is different from the first pressure pB is located in an outside area of the valve.

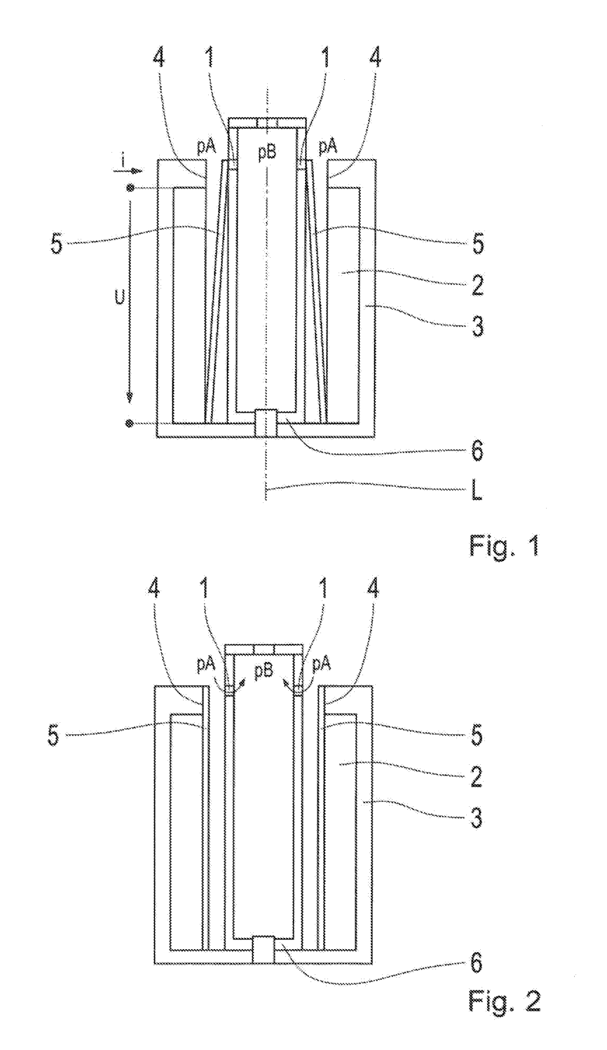

To open the valve, the coil 2 is electrically powered. As explained, a magnetic field thus forms in the area of the coil 2 which acts on the spring tongues 5. With a sufficiently high electrical current by the coil, the magnetic force thereby forming in the spring tongues 5 lifts it off the valve openings 1. The spring tongues 5 then place themselves against the respective pole shoe or shoes 4. This is represented in FIG. 2. The valve openings 1 are released accordingly so that fluid can flow through the valve, which is represented by respective arrows in FIG. 2. The result is therefore an adjustment of pressure pA and pB.

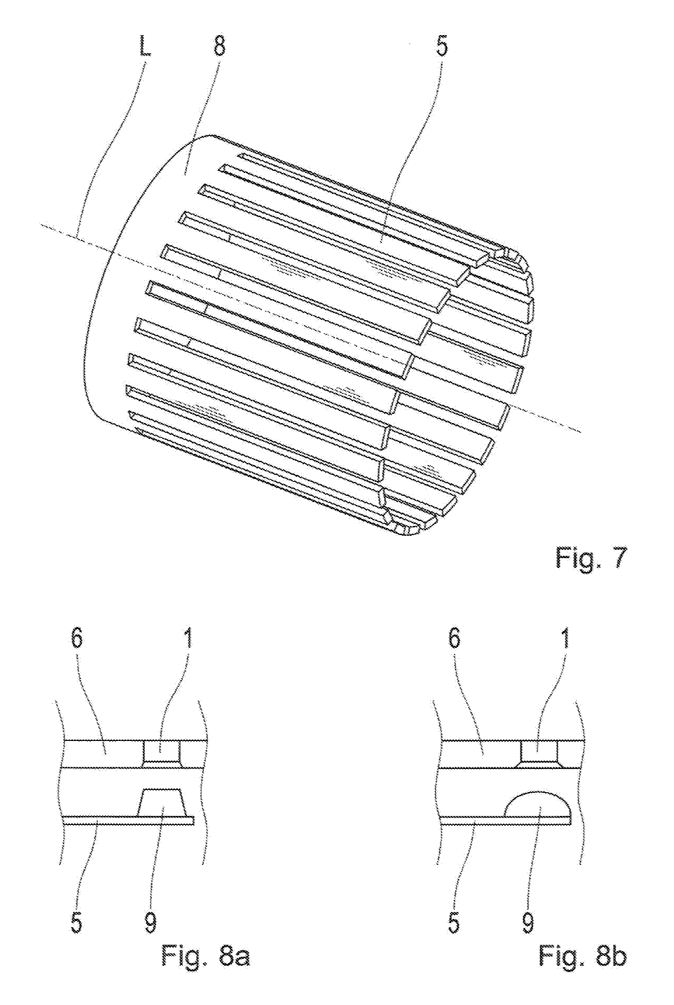

As is visible in FIGS. 1 and 2, the spring tongues 5 are preferably arranged in longitudinal direction L of the coil 2. In the embodiment according to FIGS. 1 and 2, the coil surrounds a valve core 6, in which the first valve openings are intended. The valve core 6 is preferably executed cylindrically, especially like the shape of a hollow cylinder. The valve core 6 is preferably arranged coaxially to the coil 2. The spring tongues 5 are preferably arranged radially between the coil and the valve core 6. The valve openings 1 are preferably executed right-angled to the longitudinal axis L of the coil and as cylindrical openings such as bores, for example. The spring tongues 5 are preferably fastened to or arranged on a joint carrier element. One unit consisting of a carrier element and spring tongue 5 is represented in FIG. 7 by way of example.

As can be seen from FIG. 1, the suggested valve is executed simply and with few components. Compared to conventional closing elements of a valve, such as a valve gate, for example, the spring tongues 5 are executed very light. A high valve dynamic (quick closing and opening times) can hereby be achieved. The valve is very insensitive to contamination as the spring tongues 5 work as seat valves with the respectively assigned first valve openings. There is therefore virtually no mechanical friction in the inside of the valve when activating the valve. The valve can therefore be operated particularly energy-efficient. It is furthermore low-wear because of it. Elements that are usually in valves such as magnet armature, return spring and valve piston present in common valves are not required here. The valve is therefore also particularly light. It should be noted that the spring tongues 5 can usually comprise a closure such as is shown in FIGS. 8a and 8b to close the respective assigned valve opening 1.

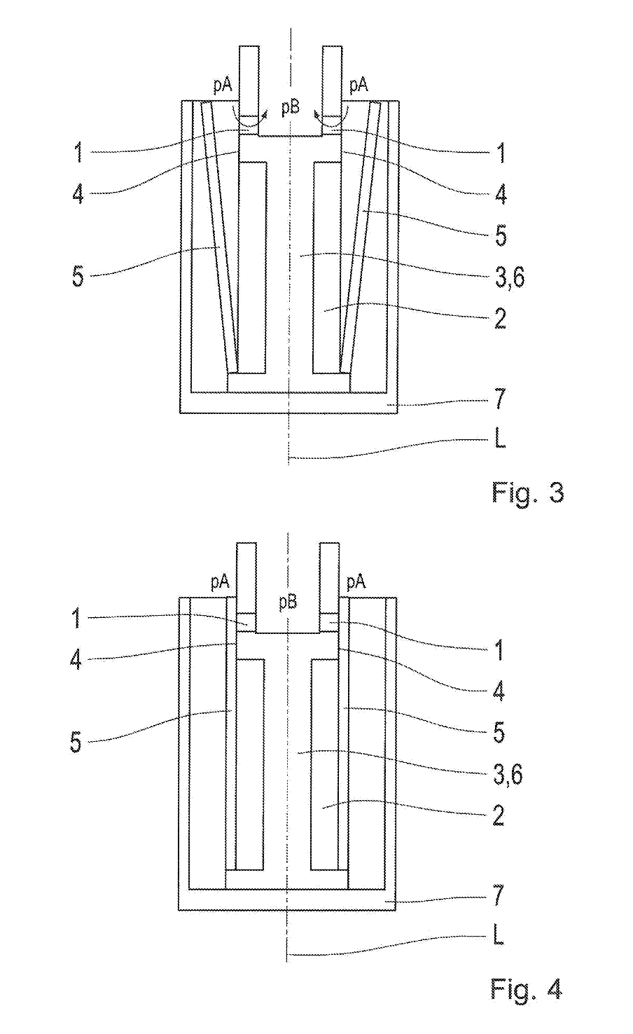

FIGS. 3 and 4 show a second preferred embodiment of the valve. The coil 2 is also carried through the magnet yoke 3 here as well. The spring tongues 5 are however arranged radially outside the coil 2. The magnet yoke 3 simultaneously forms the valve core 6, in which the first valve openings 1 are arranged. The spring tongues 5 are pre-stressed so that they protrude from the valve openings 1 in their initial position when the coil is not powered. A fluid flow through the first valve openings 1 and therefore the valve is thereby possible, the valve is open.

In contrast to the design of the valve according to FIGS. 1 and 2, the version according to FIGS. 3 and 4 is therefore executed normally-opened. In comparison, the variant according to FIGS. 1 and 2 is executed normally-closed. As is shown in FIG. 3 and FIG. 4, the magnet yoke 3 can be arranged in a valve housing 7 together with the coil 2 and the spring tongues 5. The spring tongues 5 also extend in longitudinal direction L of the coil 2 in the design according to FIGS. 3 and 4. The spring tongues 5 are preferably attached to a joint carrier element here as well.

FIG. 4 shows the valve from FIG. 3 in an actuated state, therefore when the coil 2 is powered sufficiently strong. The spring tongues 5 then place themselves against the corresponding pole shoe 4 each and thereby close the respective first valve opening 1. A fluid flow through the first valve openings 1 and the valve is thereby interrupted, the valve is closed.

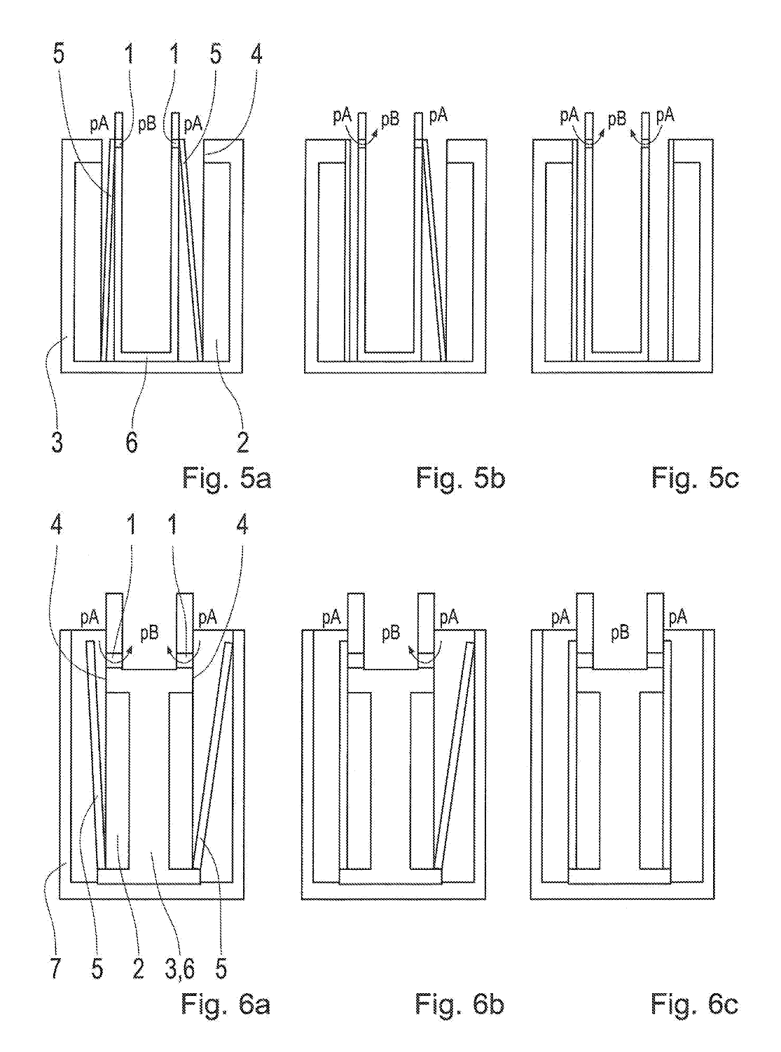

The valve is preferably designed such that the fluid flow or the flow cross-section of the valve adjusts in dependence of the electrical current strength supplied to the coil 2. Simply a specific pressure or a specific volume flow of the flowing fluid can thus be set with the valve. The FIGS. 5a to 5c show a slight variation of the valve according to FIGS. 1 and 2, in which this is possible. In contrast, the FIGS. 6a to 6c show a slight variation of the valve according to FIGS. 3 and 4, in which this is possible.

In the embodiment according to FIGS. 5a to 5c, the longitudinal axis of the valve core 6 is slightly offset towards the longitudinal axis of the coil 2. This results in different pre-stressing of the spring tongues 5 to the respectively assigned first valve openings 1. Instead of shifting the valve core 6 inside the valve, this can also be effectuated by a different spring stiffness of the spring tongues 5. It is also possible that the spring tongues 5 have different spring constants, or that the at least two of the spring tongues 5 are shaped different geometrically or that the at least two of the spring tongues 5 consist of different magnetically effective materials, or that the pole shoes 4 are shaped different geometrically. A combination of these possibilities is however also conceivable.

FIG. 5a shows the valve in an unpowered state. The spring tongues 5 are there in their initial position, in which they lie against the respective first valve opening 1 and which thereby close these.

The valve is represented in FIG. 5b, when it is powered with a first (low) electrical current. The magnetic field thus generated in the coil 2 is sufficiently strong to at least lift one of the spring tongues 5 (the left spring tongue 5 in FIG. 5b) from the respective first valve opening 1 and to place it against the respective pole shoe 4). The magnetic field is however not strong enough to lift at least one of the other spring tongues 5 (the right spring tongue in FIG. 5b) from the respective first valve opening. A part of the valve openings 1 thus remains closed during the powering of the valve shown in FIG. 5b, while another part of the valve openings 1 is already opened.

In FIG. 5c, the valve is powered with a second (relatively strong) electrical current. A respectively strong magnetic field has thus formed in the coil 2. This one is sufficient to lift all the spring tongues 5 from the respective assigned first valve openings 1 and to place them against the respective pole shoe 4. The first valve openings 1 are therefore all fully opened. The valve is therefore in the maximum opened position overall.

By using a multitude of spring elements 5 and respective assigned first valve openings 1, an almost current-proportional opening or closing of the valve can thus be achieved.

In accordance with the embodiment according to FIG. 6a to FIG. 6c, a current-proportional opening or closing of the valve is achieved by that the spring tongues 5 are spaced differently far from the respective first valve opening 1 in their initial position, when the coil 2 doesn't generate a magnetic field. This can naturally also be combined with the measures described above or the measures described above may also be used individually here or in combination.

As can be seen from FIG. 6a, when the valve is in unpowered condition, there is at least one spring element 5 (the left spring element 5 in FIG. 6a) that is closer to the respective valve opening 1 than a second of the spring elements 5 (the right spring element 5 in FIG. 6a). Both valve openings 1 are therefore in opened condition in this valve position.

According to FIG. 6b, the coil 2 is powered with a first (relatively weak) electrical current. The magnetic field hereby generated by means of the coil 2 is strong enough to place the valve tongue 5 that is closer to the respective vale opening 1 against the respective pole shoe 4 and the valve opening 1. At least one of the valve openings 1 is thus closed. In contrast, the magnetic field is not strong enough to pull in the spring element 5 that is distanced further away from the respective valve opening 1 and to thereby place it against this valve opening. Correspondingly, this valve opening is still opened. The valve is hereby partially closed/opened.

According to FIG. 6c the valve is powered with a second (relatively strong) electrical current. The magnetic field generated by means of the coil 2 is therefore strong enough to place all spring tongues 5 against the respectively appropriate first valve openings 1 and the pole shoe/shoes. The valve is hereby completely closed. Accordingly, an almost current-proportional operation of the valve is also possible with this embodiment.

FIG. 7 shows a particularly preferred embodiment of spring tongues 5 for the proposed valve. The spring tongues 5 are hereby formed in one piece with a joint carrier element. The spring tongues 5 are hereby arranged ring-shaped or tubular. The carrier element 8 also forms a closed ring. Spring elements 5 that are designed that way may be arranged radially inside or outside of a coil 2 to operate a valve (e.g. in the versions according to FIG. 1/2 or FIG. 3/4), for example. Such spring tongues 5 can be made, for example by that a closed ring is provided with several longitudinal slots that start at a front of the ring. The ring may be made from spring steel, for instance, or another magnetically effective and sufficiently elastic material. Such a ring made from spring elements 5 is therefore particularly easy to produce.

FIGS. 8a and 8b show an example of one spring element 5 each with a closure 9 that is attached to it or executed or stamped as well as the valve opening 1 that is part of the spring tongue 5 and that corresponds with the closure 9. As is shown in FIG. 8a, the closure 9 can be executed conical, for example, in the shape of a frustum of a cone, in particular. The closure 9 can also be executed hemispherical or in some kind of a hemisphere or rounded as is portrayed in FIG. 8b. Accordingly, the valve seats in the valve openings 1 are executed correspondingly conical or hemispherical, etc. By means of such a closure 9, the sealing effect can be increased significantly. The closure 9 may, for instance, be an extra component applied onto the respective spring tongue 5. Alternatively, the closure 9 may also be formed by the respective spring tongue 5 itself, for example, by stamping a respective shape into the spring tongue 5 or by being extruded from it otherwise.

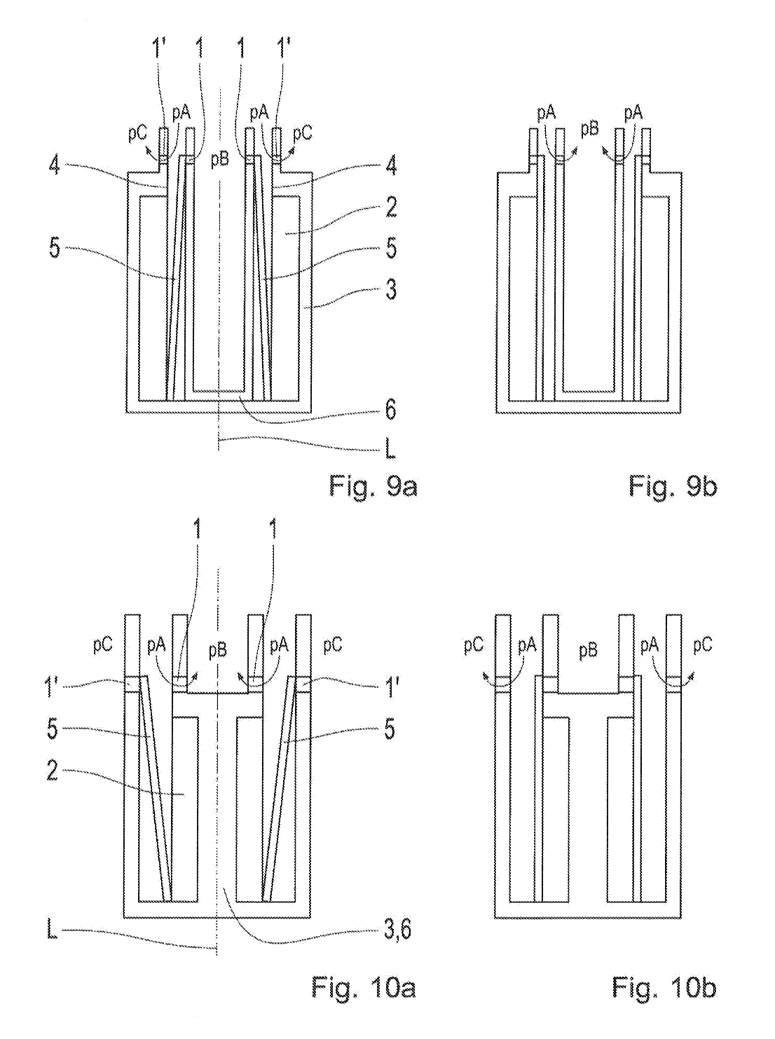

FIG. 9a and FIG. 9b show a variant of the valve from FIGS. 1 and 2 in different switch positions, whereby the valve is executed as a 3/2 valve. As is visible in FIG. 9a, beside the first valve openings 1, the valve also has second valve openings 1′. Each first valve opening 1 thereby comprises a spring tongue 5 and a second valve opening 1′ assigned to it. The spring tongues 5 reciprocally either close the respective first or second valve opening 1, 1′.

In the initial position of the valve shown in FIG. 9a, the spring tongue 5 closes the first valve openings 1. Accordingly, the second valve openings 1′ are opened. During a sufficiently strong powering of the coil 2, the spring tongues 5 lift themselves up from the first valve openings 1 and thereby open these and place themselves against the pole shoes 4 and the respectively assigned second valve openings 1′. The second valve openings 1′ are hereby closed. This valve position is shown in FIG. 9b. A fluid flow can hereby be lead through the first or second valve openings 1, 1′ optionally depending on the powering of the valve. Intermediate positions are also possible, in which the valve openings 1, 1′ are opened at the same time (partially) depending on the position of the spring tongues 5.

FIGS. 10a and 10 b show a variant of the valve represented in FIGS. 3 and 4 in a 3/2 valve design. Analog to FIGS. 9a and 9b, this valve also has two valve openings 1′. These are each assigned to one of the spring tongues 5 and one of the first valve openings 1 here as well. The respective spring tongue 5 therefore closes the respective assigned first and second valve opening 1, 1′ reciprocally. In the initial position according to FIG. 10a, the two valve openings 1 a are closed by means of the spring elements 5. In powered condition of the valve, the spring tongues 5 place themselves against the pole shoes 4 and the first valve openings 1, whereby these are closed. By contrast, the second valve openings 1′ are opened. This is shown in FIG. 10b. A fluid flow can optionally be lead through the first or second valve openings 1, 1′ hereby as well. Intermediate positions are also possible here, in which, depending on the position of the spring tongues 5, the valve openings are opened (partially) at the same time.

The 3/2 valves created this way have the same advantages as the valves (FIGS. 1 to 6c) explained above. A current-proportional opening or closing of the valve openings 1, 1′ can also be achieved with the valves according to FIGS. 9a, 9b, and 10a, 10b by taking the measures explained above (e.g. FIGS. 5a to 5c, and FIGS. 6a to 6c).

The valves suggested can be used, in particular, for the regulation or control of a pressure or a volume flow, for instance in hydraulics or in pneumatics.

### REFERENCES SIGNS

1, 1′ Valve opening

2 Coil

3 Magnet yoke

4 Pole shoe

5 elastic valve piston segment, spring tongue

6 Valve core

7 Valve housing

8 Carrier element

9 Closure

L Longitudinal axis

pA Pressure

pB Pressure

pC Pressure

1. An electrically operable valve, the valve comprising:
an electrical coil;
a plurality of spring tongues that are movable by a magnetic field generated by the electrical coil between a first switch position and a second switch position; and
a plurality of valve openings which are open when the plurality of spring tongues are in the first switch position and which are closed when the spring tongues are in the second switch position.

2. The valve of claim 1, wherein each of the plurality of valve openings is assigned to one of the plurality of spring tongues; wherein the valve further comprises a closure arranged on each of the plurality of spring tongues; and wherein the closure closes the assigned valve opening when the assigned spring tongue is in the second switch position.

3. The valve of claim 1, wherein each of the plurality of valve openings is assigned to one of the plurality of springs tongue; and wherein the valve is executed such that at least two of the plurality of spring tongues open and close the assigned valve openings of the at least two of the plurality of spring tongues with different magnetic field strengths.

4. The valve of claim 3, wherein the at least two of the plurality of spring tongues have different spring constants; and/or
the at least two of the plurality of spring tongues in an initial position, are pre-stressed differently against the assigned valve openings; and/or
the at least two of the plurality of spring tongues in the initial position, are spaced differently from the assigned valve openings; and/or
the at least two of the plurality of spring tongues have different geometric shapes; and/or
the at least two of the plurality of spring tongues comprise different magnetically effective materials; and/or
the valve further comprising a plurality of pole shoes, against which the at least two of the plurality of spring tongues place themselves against in actuated condition when the coil generates a magnetic field to operate the valve, are formed having different geometric shapes, so that the at least two of the plurality of spring tongues open or close the assigned valve openings with different magnetic field strengths.

5. The valve of claim 1 further comprising a plurality of second valve openings, which are assigned to one of the plurality of spring tongues and to one of the plurality first valve openings such that each of the plurality of first valve openings is opened in the first switch position and each of the plurality of second valve openings is closed by the spring tongue, and that each of the plurality of second valve openings is opened in the second switch position and each of the plurality of first valve openings is closed by the spring tongue.

6. The valve of claim 1, wherein the plurality of spring tongues are arranged on a joint carrier element.

7. The valve of claim 1, wherein the plurality of spring tongues are arranged in a longitudinal axis of the coil.

8. The valve of claim 7, wherein the plurality of spring tongues are ring-shaped and the longitudinal axis of each of the plurality of spring tongues is arranged coaxially or in parallel to the longitudinal axis of the coil.

9. The valve of claim 8, wherein the plurality of valve openings that run radially to the longitudinal axis of the coil.

10. The valve of claim 1, wherein the plurality of spring tongues are arranged radially outside or inside the coil.

11. The valve of claim 2, wherein the valve is executed such that at least two of the plurality of spring tongues open and close the assigned valve openings with different magnetic field strengths.

12. The valve of claim 11, wherein the at least two of the plurality of spring tongues have different spring constants; and/or
the at least two of the plurality of spring tongues in an initial position are pre-stressed differently against the assigned valve openings; and/or
the at least two of the plurality of spring tongues in the initial position are spaced differently from the assigned valve openings; and/or
the at least two of the plurality of spring tongues have different geometric shapes; and/or
the at least two of the plurality of spring tongues comprise different magnetically effective materials; and/or
the valve further comprising a plurality of pole shoes, against which the at least two of the plurality of spring tongues place themselves against in actuated condition when the coil generates a magnetic field to operate the valve, are formed having different geometric shapes, so that the at least two of the plurality of spring tongues open or close the assigned valve openings with different magnetic field strengths.

13. The valve of claim 2 further comprising a plurality of second valve openings, which are assigned to one of the plurality of spring tongues and to one of the plurality first valve openings such that each of the plurality of first valve openings is opened in the first switch position and each of the plurality of second valve openings is closed by the spring tongue, and that each of the plurality of second valve openings is opened in the second switch position and each of the plurality of first valve openings is closed by the spring tongue.

14. The valve of claim 3 further comprising a plurality of second valve openings, which are assigned to one of the plurality of spring tongues and to one of the plurality first valve openings such that each of the plurality of first valve openings is opened in the first switch position and each of the plurality of second valve openings is closed by the spring tongue, and that each of the plurality of second valve openings is opened in the second switch position and each of the plurality of first valve openings is closed by the spring tongue.

15. The valve of claim 2, wherein the plurality of spring tongues are arranged on a joint carrier element.

16. The valve of claim 3, wherein the plurality of spring tongues are arranged on a joint carrier element.

17. The valve of claim 2, wherein the plurality of spring tongues are arranged in a longitudinal direction of the coil.

18. The valve of claim 3, wherein the plurality of spring tongues are arranged in a longitudinal direction of the coil.

19. The valve of claim 2, wherein the plurality of spring tongues are arranged radially outside or inside the coil.

20. The valve of claim 3, wherein the plurality of spring tongues are arranged radially outside or inside the coil.
